(19) United States
(12) Patent Application Publication
(10) Pub. No.: US 2011/0078057 A1
(43) Pub. Date: Mar. 31, 2011

(54) METHOD, APPARATUS AND COMPUTER PROGRAM PRODUCT FOR PROVIDING MANAGEMENT OF A GENERICS PROGRAM

(76) Inventors: Holly Lewis, Colliers, WV (US); Margaret Safoniuk, Port Coquitlam (CA)

(21) Appl. No.: 12/570,641

(22) Filed: Sep. 30, 2009

(51) Int. Cl. G06Q 10/00; G06F 3/048

(52) U.S. Cl. 705/28; 715/771

(57) ABSTRACT

A method for providing management of a generics program may include determining, for a remote facility among a plurality of remote facilities in communication with a distributor, inventory items in an inventory list that correspond to a generics program, providing an indicator of generics program inclusion to the remote facility in response to a determination that a particular inventory item corresponds to the generics program, and enabling display at the remote facility of an identifier in association with the particular inventory item. A corresponding computer program product and apparatus are also provided.

### TECHNOLOGICAL FIELD

Embodiments of the present invention relate generally to health care management solutions and, more particularly, relate to a solution for providing enterprise wide monitoring of generics program compliance and for facilitating compliance.

### BACKGROUND

The healthcare industry is under continued pressure to keep costs relatively low while still offering excellent service. While these pressures can extend to all areas of healthcare, one area of note relates to the dispensing of medication and, in particular, prescribed medications. Although many over the counter (OTC) medications are obtainable for treating certain ailments that are routine and/or can be self treated, doctors often prescribe medications that are, for various reasons, regulated by law. Prescription medications are typically either branded drugs or generic drugs. Branded drugs are typically drugs that are protected by a patent. Generic drugs are drugs that are not protected by patent and typically contain the same active ingredient as a corresponding branded drug. Because branded drugs enjoy the benefit of patent protection, branded drugs are typically more expensive than generic drugs.

In the world of retail pharmacy, where many prescriptions are filled, patients, insurance companies and other parties may all desire to see generic drugs used where possible to keep costs down. Automation of certain dispensing related procedures and the introduction of computer applications to manage inventory and determine when and what generic drugs might be available to fill a prescription have also been introduced to keep costs down. However, there are many different retail pharmacy chains and smaller retail pharmacy operations throughout the country and around the world. There are also a relatively large number of drug suppliers that may supply retail pharmacies with branded and various generic drugs in accordance with various contracts between the parties. The drug suppliers may also have contracts with drug manufacturers that impact the cost of drugs they supply to the pharmacies they serve. Accordingly, it is a non-trivial problem to develop software to assist pharmacies in dispensing medications.

In some cases, the contracts may specify discounts or other incentives for using the generic drugs supplied by a particular supplier. However, tracking of compliance with contract provisions may be difficult due to the relatively large number of drugs involved and the varying demands for each type. Complicating the factors above, the providers of the software used in order to assist in dispensing medication are often not involved in the supplying of the medications and therefore may not be aware of the contracts that the retail pharmacy has with its supplier to enable the pharmacy to track generic program compliance (e.g., the identification and distribution of preferred generic drugs in accordance with contract provisions in order to maximize the benefit to the contracted parties and patients). Although some software applications may enable the user to manually identify preferred generics, the process of manually configuring the software to alert pharmacists that a particular generic is part of a generic compliance program may be tedious and complicated. Accordingly, there may be inefficiencies introduced into the system described above and it may be desirable to provide a mechanism by which generics compliance may be facilitated and monitoring may be improved.

### BRIEF SUMMARY

A method, apparatus and system are therefore provided to enable the provision of enterprise wide monitoring of generics program compliance and facilitating compliance that may address some of the problems discussed above. Accordingly, for example, a mechanism may be provided to identify program generics to facilitate generics compliance and also enable the coordination and reporting of information related to generics compliance.

In one exemplary embodiment, a method for providing management of a generics program may include determining, for a remote facility among a plurality of remote facilities in communication with a distributor, inventory items in an inventory list that correspond to a generics program, providing an indicator of generics program inclusion to the remote facility in response to a determination that a particular inventory item corresponds to the generics program, and enabling display at the remote facility of an identifier in association with the particular inventory item.

In another exemplary embodiment, a computer program product for providing management of a generics program is provided. The computer program product may include at least one computer-readable storage medium having computer-executable program code instructions stored therein. The computer-executable program code instructions may include program code instructions for determining, for a remote facility among a plurality of remote facilities in communication with a distributor, inventory items in an inventory list that correspond to a generics program, providing an indicator of generics program inclusion to the remote facility in response to a determination that a particular inventory item corresponds to the generics program, and enabling display at the remote facility of an identifier in association with the particular inventory item.

In another exemplary embodiment, an apparatus for providing management of a generics program is provided. The apparatus may include processing circuitry. The processing circuitry may be configured for determining, for a remote facility among a plurality of remote facilities in communication with a distributor, inventory items in an inventory list that correspond to a generics program, providing an indicator of generics program inclusion to the remote facility in response to a determination that a particular inventory item corresponds to the generics program, and enabling display at the remote facility of an identifier in association with the particular inventory item.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a block diagram illustrating a system for providing improved generics program compliance according to an exemplary embodiment of the present invention;

FIG. 2 is a block diagram showing various components that may be included in an apparatus for providing improved generics program compliance according to an exemplary embodiment of the present invention;

FIG. 3 illustrates a screenshot of a generic substitution tool showing an example of an icon according to an exemplary embodiment of the present invention;

FIG. 4 illustrates a full workflow header with an item indicated as being a program generic by virtue of its association with the icon according to an exemplary embodiment of the present invention;

FIG. 5 illustrates an express fill header with an item indicated as being a program generic by virtue of its association with the icon according to an exemplary embodiment of the present invention;

FIG. 6 illustrates a long term care header with an item indicated as being a program generic by virtue of its association with the icon according to an exemplary embodiment of the present invention;

FIG. 7 shows a supplier tab indicating supplier item information including information about an item that is in the generics program as indicated by the icon according to an exemplary embodiment of the present invention;

FIG. 8 shows an example of a product ordering group tab with several products that are program generics as indicated by the icon according to an exemplary embodiment of the present invention;

FIG. 9 is a screenshot of an example product search tab according to an exemplary embodiment of the present invention;

FIG. 10 is a screenshot of an example inventory search tab according to an exemplary embodiment of the present invention;

FIG. 11 illustrates a product search in purchasing/receiving tab with an item indicated as being a program generic by virtue of its association with the icon according to an exemplary embodiment of the present invention;

FIG. 12 illustrates a purchase order detail tab with an item indicated as being a program generic by virtue of its association with the icon according to an exemplary embodiment of the present invention; and

FIG. 13 is a block diagram according to an exemplary method for providing improved generics program compliance according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As indicated above, embodiments of the present invention are aimed at providing a mechanism by which compliance with a generics program may be facilitated and monitored. In some embodiments, a solution is provided to flag or otherwise identify inventory items that are program generics (e.g., generic drugs for which particular incentive or contract based provision is applicable) to dispensing personnel. Some embodiments of the solution not only provide improved clarity and ease of identification of drugs that are program generics, but further enable monitoring and reporting on compliance with the generic program of the corresponding entity at which the solution operates. Accordingly, for example, improved program compliance may increase the rebates for which the retailer qualifies, may increase profitability of both the retailer and distributor and may pass more savings along to customers.

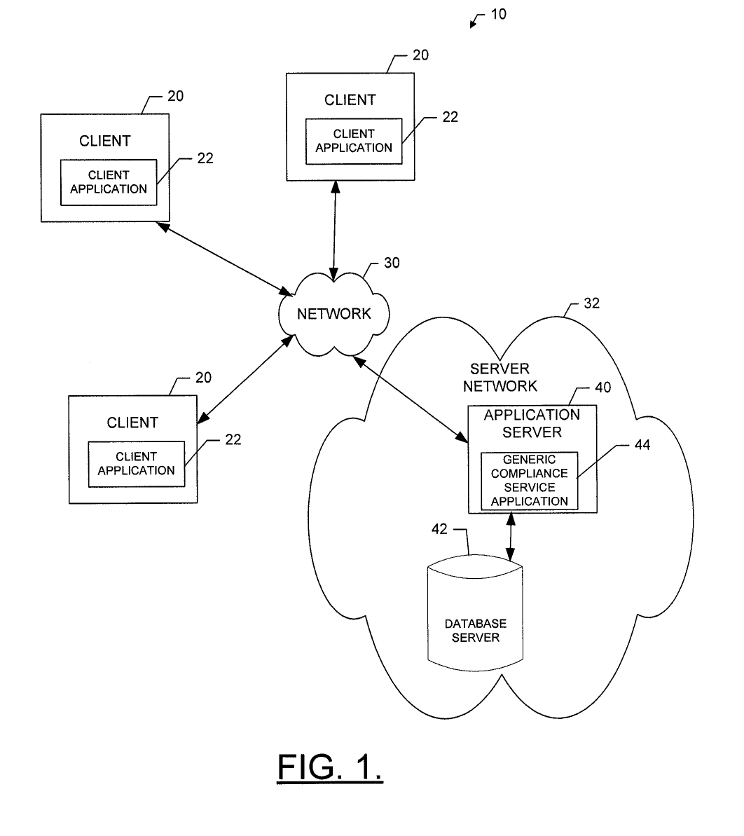

An exemplary embodiment of the invention will now be described in reference to FIG. 1, which illustrates an exemplary system in which an embodiment of the present invention may be employed. As shown in FIG. 1, a system 10 according to an exemplary embodiment may include one or more client devices or clients 20 that may, in some cases, be associated with different corresponding remote facilities such as retail outlets or pharmacies. For example, one client 20 may be associated with a first retail pharmacy and a second client 20 may be associated with a second retail pharmacy. Although the clients 20 may be situated in the same region associated with a regional distributor of pharmaceuticals, there is no requirement for any regional segregation. As such, clients 20 could be distributed anywhere throughout the country or even the globe. However, in some cases, separate systems for different regional distributors may be employed, or one system may include different regional based groupings of clients.

Each client 20 may be, for example, a computer (e.g., a personal computer, laptop computer, network access terminal, or the like) or may be another form of computing device capable of communication with a network 30. As such, for example, each client 20 may include (or otherwise have access to) memory for storing instructions or applications for the performance of various functions and a corresponding processor for executing stored instructions or applications. Each client 20 may also include software and/or corresponding hardware for enabling the performance of the respective functions of the clients as described below. In an exemplary embodiment, one or more of the clients 20 may include a client application 22 configured to operate in accordance with an exemplary embodiment of the present invention. In this regard, for example, the client application 22 may include software for enabling a respective one of the clients 20 to communicate with the network 30 for the provision of and receipt of information associated with providing generics program compliance functions. As such, for example, the client application 22 may include corresponding executable instructions for configuring the client 20 to provide corresponding functionalities for the provision of and receipt of information associated with providing the generics program compliance monitoring and facilitation functions as described in greater detail below. Moreover, in an exemplary embodiment, the client application 22 may include functionality for providing access to a suite of pharmacy related applications that enable searching for particular products, searching for generic substitutes for particular branded drugs, inventory searching, and other functions associated with managing, ordering and distributing medications including branded and generic drugs. As an example, the client application 22 could be similar to a client side application of the EnterpriseRx™ pharmacy management system offered by McKesson. As such, among other things the client application 22 may enable access to programs or individual user interface consoles such as Product Search, Generic Substitution Search, Inventory Search, Inventory Details, Workflow Header, Long Term Care Header, and the Express Fill Header of the EnterpriseRx™ pharmacy management system.

The network 30 may be a data network, such as a local area network (LAN), a metropolitan area network (MAN), a wide area network (WAN) (e.g., the Internet), and/or the like, which may couple the clients 20 to devices such as processing elements (e.g., personal computers, server computers or the like) or databases. Communication between the network 30, the clients 20 and the devices or databases (e.g., servers) to which the clients 20 are coupled may be accomplished by either wireline or wireless communication mechanisms and corresponding protocols.

In an exemplary embodiment, one of the devices to which the clients 20 may be coupled via the network 30 may include one or more application servers (e.g., application server 40), and/or a database server 42, which together may form respective elements of a server network 32, which may be located in a regional or universal data center. Although the application server 40 and the database server 42 are each referred to as “servers”, this does not necessarily imply that they are embodied on separate servers or devices. As such, for example, a single server or device may include both entities and the database server 42 could merely be represented by a database or group of databases physically located on the same server as the application server 40. The application server 40 and the database server 42 may each include hardware and/or software for configuring the application server 40 and the database server 42, respectively, to perform various functions. As such, for example, the application server 40 may include processing logic and memory enabling the application server 40 to access and/or execute stored computer readable instructions for performing various functions. In an exemplary embodiment, one function that may be provided by the application server 40 may be the provision of generics program compliance monitoring and facilitation to the clients 20 via providing an extension to the pharmacy management system. In this regard, for example, the application server 40 may include a generic program compliance service application 44 comprising stored instructions for accessing information and providing such information to the client applications 22 based on requests provided at each respective client 20.

Additionally or alternatively, the application server 40 may be configured to enable the clients 20 to provide information to the application server 40, for use by the application server 40 in producing, maintaining and/or supplying the generic program compliance related information. In this regard, for example, the application server 40 (or servers) may include particular applications related to various different pharmacy management functions. As such, some application servers may host applications that grant clients 20 access to the suite of pharmacy related applications described above (e.g., applications that enable searching for particular products, searching for generic substitutes for particular branded drugs, inventory searching, and other functions associated with managing, ordering and distributing medications including branded and generic drugs, and/or the like). Each of the pharmacy related applications that may be supported by the application server may also exchange information with clients 20 via the network 30. In an exemplary embodiment, the application server 40 may include or have access to memory (e.g., internal memory or the database server 42) for storing instructions or applications for the performance of various functions and a corresponding processor for executing stored instructions or applications.

In an exemplary embodiment, the database server 42 may include one or more volatile or non-volatile memory devices for storing various types of information related to pharmacy management. Thus, for example, the database server 42 may store, for example, any or all of inventory information, drug facts, drug interaction data, generic substitution data, contract data, and/or the like. The data stored in the database server 42 may be available for querying or searching, recording monitored data, reporting recorded data, providing information to and/or driving applications such as, for example, the generic program compliance service application 44 or the client application 22.

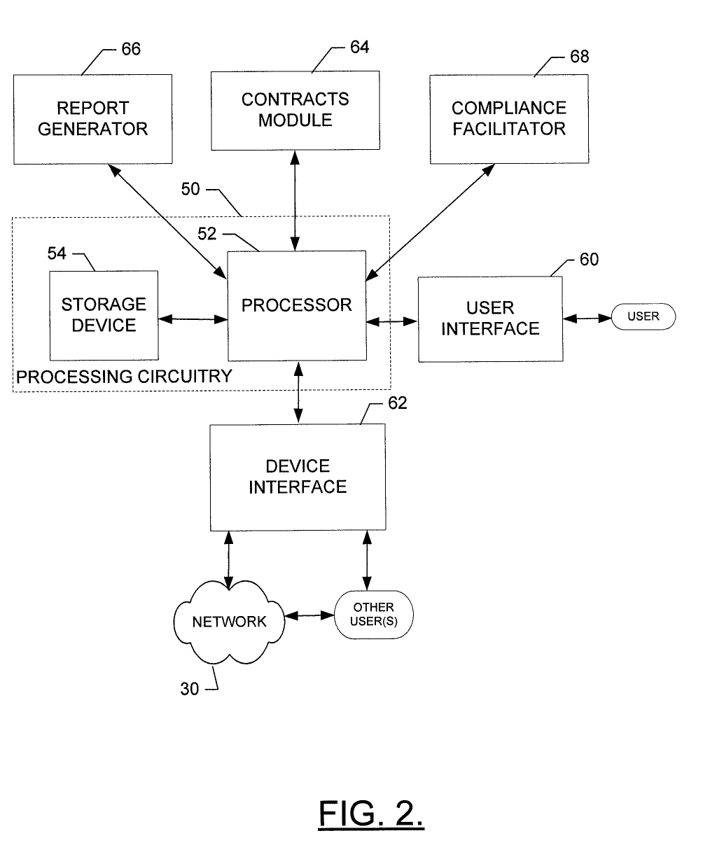

An exemplary embodiment of the invention will now be described with reference to FIG. 2. FIG. 2 shows certain elements of an apparatus for providing generics program compliance monitoring and facilitation according to an exemplary embodiment. The apparatus of FIG. 2 may be employed, for example, on a client (e.g., any of the clients 20 of FIG. 1) or a variety of other devices (such as, for example, a network device, server, proxy, or the like (e.g., the application server 40 of FIG. 1)). Alternatively, embodiments may be employed on a combination of devices. Accordingly, some embodiments of the present invention may be embodied wholly at a single device (e.g., the application server 40) or by devices in a client/server relationship (e.g., the application server 40 and one or more clients 20). Furthermore, it should be noted that the devices or elements described below may not be mandatory and thus some may be omitted in certain embodiments.

Referring now to FIG. 2, an apparatus for providing generics program compliance monitoring and facilitation is provided. The apparatus may include or otherwise be in communication with processing circuitry 50 that is configured to perform data processing, application execution and other processing and management services according to an exemplary embodiment of the present invention. In one embodiment, the processing circuitry 50 may include a processor 52, a storage device 54 that may be in communication with or otherwise control a user interface 60 and a device interface 62. As such, the processing circuitry 50 may be embodied as a circuit chip (e.g., an integrated circuit chip) configured (e.g., with hardware, software or a combination of hardware and software) to perform operations described herein. However, in some embodiments, the processing circuitry 50 may be embodied as a portion of a server, computer, laptop, workstation or even one of various mobile computing devices. In situations where the processing circuitry 50 is embodied as a server or at a remotely located computing device, the user interface 60 may be disposed at another device (e.g., at a computer terminal or client device such as one of the clients 22) that may be in communication with the processing circuitry 50 via the device interface 62 and/or a network (e.g., network 30).

The user interface 60 may be in communication with the processing circuitry 50 to receive an indication of a user input at the user interface 60 and/or to provide an audible, visual, mechanical or other output to the user. As such, the user interface 60 may include, for example, a keyboard, a mouse, a joystick, a display, a touch screen, a microphone, a speaker, a cell phone, or other input/output mechanisms.

The device interface 62 may include one or more interface mechanisms for enabling communication with other devices and/or networks. In some cases, the device interface 62 may be any means such as a device or circuitry embodied in either hardware, software, or a combination of hardware and software that is configured to receive and/or transmit data from/to a network and/or any other device or module in communication with the processing circuitry 50. In this regard, the device interface 62 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 62 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an exemplary embodiment, the storage device 54 may include one or more memory devices such as, for example, volatile and/or non-volatile memory that may be either fixed or removable. The storage device 54 may be configured to store information, data, applications, instructions or the like for enabling the apparatus to carry out various functions in accordance with exemplary embodiments of the present invention. For example, the storage device 54 could be configured to buffer input data for processing by the processor 52. Additionally or alternatively, the storage device 54 could be configured to store instructions for execution by the processor 52. As yet another alternative, the storage device 54 may include one of a plurality of databases (e.g., database server 42) that may store a variety of files, contents or data sets. Among the contents of the storage device 54, applications (e.g., client application 22 or generic program compliance service application 44) may be stored for execution by the processor 52 in order to carry out the functionality associated with each respective application.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an exemplary embodiment, the processor 52 may be configured to execute instructions stored in the storage device 54 or otherwise accessible to the processor 52. As such, whether configured by hardware or software methods, or by a combination thereof, the processor 52 may represent an entity (e.g., physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the operations described herein.

In an exemplary embodiment, the processor 52 (or the processing circuitry 50) may be embodied as, include or otherwise control a contracts module 64, a report generator 66 and a compliance facilitator 68. The contracts module 64, the report generator 66 and the compliance facilitator 68 may each be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the contracts module 64, the report generator 66 and the compliance facilitator 68, respectively, as described below.

The apparatus of FIG. 2, which may execute the generic program compliance service application 44 by virtue of the operation of the contracts module 64, the report generator 66 and/or the compliance facilitator 68, may be maintained by a drug distributor to ensure that the end customer (e.g., the retailer) can more easily facilitate employee compliance with the retailer's desires, procedures or protocols for generic substitutions. As such, the apparatus (e.g., via the generic program compliance service application 44) may enable the retailer to tie ordering, purchasing, and inventory management functions in a single location, while simultaneously allowing the retailer to receive automatically generated generic substitution functionality to facilitate and maximize compliance and the achievement of benchmarks associated with incentive or performance based rebates. Moreover, the apparatus (e.g., via the generic program compliance service application 44) may be tailored to the specific generics program of the retailer by enabling the retailer to make the apparatus aware of the contracts of the retailer. Accordingly, contract provisions for incentive or performance based rebates may be integrated into the generic program compliance service application 44.

The contracts module 64 may be an optional component of the apparatus of FIG. 2 employed by customers that have contracts with various provisions that may impact their compliance program. As such, the contracts module 64 may be configured to extract or otherwise receive information on contract provisions associated with specific contracts associated with various customers. The contracts may be stored in the database server 42 and may be accessed by the contracts module 64 to determine various contract parameters that may impact generic compliance. For example, contracted incentive programs, rebate programs, performance programs or other provisions that define agreed pricing, rebates or other cost modifiers that may be fixed, variable, capped, threshold initiated or otherwise applicable may be referenced for the extraction of information associated with contracts. The extracted information, which may be focused on information that may impact generic drug substitution decisions, may then be provided to the compliance facilitator 68.

The compliance facilitator 68 may be configured to determine, for at least some of the clients 20 (and in some cases each of the clients 20), which inventory items in an inventory list correspond to a compliance program. As such, in some embodiments, the compliance facilitator 68 may be configured to reference contract information from the contracts module 64 in order to update file feed information provided from the application server 40 (e.g., from an inventory management or product ordering application) to the client applications 22 for each respective retail outlet (e.g., clients 20) with corresponding indicators to identify generic drugs that are part of the generic program of each retail outlet. Accordingly, each client application 22 (or at least each client application for which compliance program information can be determined) receives a corresponding set of indicators to indicate one or more, and in some cases each, of the generic drugs that are a part of the generics program of the corresponding retail outlet. As such, each retail outlet receives “personalized” information that is applicable to it, based on the contract provisions that are applicable to the retail outlet. In some embodiments, the indicators may be provided to indicate generics program items in a catalogue update or other inventory related data feed.

In an exemplary embodiment, the indicator provided to a particular one of the client applications 22 may be embodied as a flag that is set for a corresponding inventory item. The flag may then trigger or otherwise enable, for display at a graphical user interface (GUI) of the client application 22, generation of an icon or other distinctive feature to indicate that the corresponding inventory item (e.g., a specific generic drug) associated with the icon is a program generic that is available for ordering. The icon may show up on a plurality of different pages or applications associated with the pharmacy management program being operated at the respective clients 20. Thus, for example, within the context of the example application described above (e.g., McKesson's EnterpriseRx™) a branded logo or other icon may appear in association with generic drugs that are suggested according to the generic drug purchasing program for which each corresponding retail outlet or chain has contracted.

As such, the generic program compliance service application 44 may be configured to support a single and unique generic formulary per facility. The compliance facilitator 68 may be configured to support this functionality by enabling determining, for a respective remote facility among a plurality of remote facilities in communication with a central node (e.g., the data center or application server 40), which inventory items in an inventory list correspond to inventory items associated with a compliance program. More specifically, the compliance facilitator may be configured to determine which inventory items are in the particular compliance program of the facility of each respective facility. In some cases, such as where certain remote facilities have not contracted for specific generic drug rebates or pricing, the compliance facilitator 68 may be configured to identify inventory items that are suggested for purchase. The functionality described above may be applicable to different formularies, such as a retail formulary and a long term care formulary.

In an exemplary embodiment, after an indicator is provided to a remote facility to indicate an item associated with a compliance program via a data feed records may be stored in a log file (e.g., at the database server 42). In some cases, the recordation of data feed activity may be accomplished by adding information to a vendor item table to indicate, at the vendor item level, that a particular generic drug was indicated as being a program generic.

In some embodiments, a user at any one of the clients 20 may be enabled to interact with the system in order to configure the system for service tailored to the needs or desires of the remote facility with which the user is associated. Thus, for example, users associated with remote facilities may have access rights to configure the generic program compliance service application 44 under some circumstances. The access rights may have varying scopes. For example, in some cases, the user may only have access rights that permit enabling or disabling the functionality described above. In other words, the user may be able to turn on program generic indicators or turn them off. Similarly, operators at the data center may be able to enable or disable functionality for a selected remote facility. Users at remote facilities or at the data center may also have the ability to control some display features associated with the presentation of the icons indicating inventory items that are program generics.

As indicated above, the indicator provided for any particular inventory item may be used to generate an icon for display at the client 20 of a respective remote facility to indicate that the corresponding inventory time is a program generic. Since the client application 22 of each client 20 may be configured to display a number of different screens, each of which may have a corresponding different functionality for interfacing with the generic program compliance service application 44, embodiments of the present invention may provide for presentation of an icon for inventory items indicated as being program generics (or suggested generics) in a plurality of the different screens that are available. For example, in the context of McKesson's EnterpriseRx™, which should be understood to represent one example of a pharmacy management system, the icon may appear in any screen in which the corresponding generic drug appears. As such, although conventional pharmacy management systems offered users with the opportunity to manually enter program generics in a generic substitution tool to present an ordered substitution list based on manually inserted preferences, embodiments of the present invention may augment such functionality by further providing the icon described above in association with items that are program generics (regardless of their ordering). Moreover, in some embodiments, the presence of the icon indicating that the corresponding inventory item is a program generic, may be used in filtering logic of the substitution list in order to alter the ordering of items in the substitution list (e.g., to move the program generic to the top of the list regardless of other manual settings that may have previously been entered). Additionally, other tools or screens that present information regarding program generics may also include a presentation of the icon in associated with each respective item that is a program generic. For example, tools associated with prescription filling, product searching, inventory management, workflow management, information summaries, verification of prescriptions or orders, drug information screens, and/or the like, may each include a display of the icon, when appropriate.

The report generator 66 may be configured to access recorded information regarding product ordering and dispensing at least in relation to generic program compliance in order to enable the generation of reports for both personnel at the remote facility and personnel associated with the distributor (e.g., at the data center). In an exemplary embodiment, the report generator 66 may be configured to route reports to the distributor regarding each respective remote facility. The reports may be indicative of generic program compliance activity for each respective remote facility and may be used as a basis for communication with a corresponding remote facility regarding the performance of the remote facility relative to the generic program and/or contracts of the remote facility. The report generator 66 may also be configured to provide information to the client applications 22 of the various remote facilities to enable the remote facilities to run reports regarding the performance of the remote facility relative to the generic program and/or contracts of the remote facility.

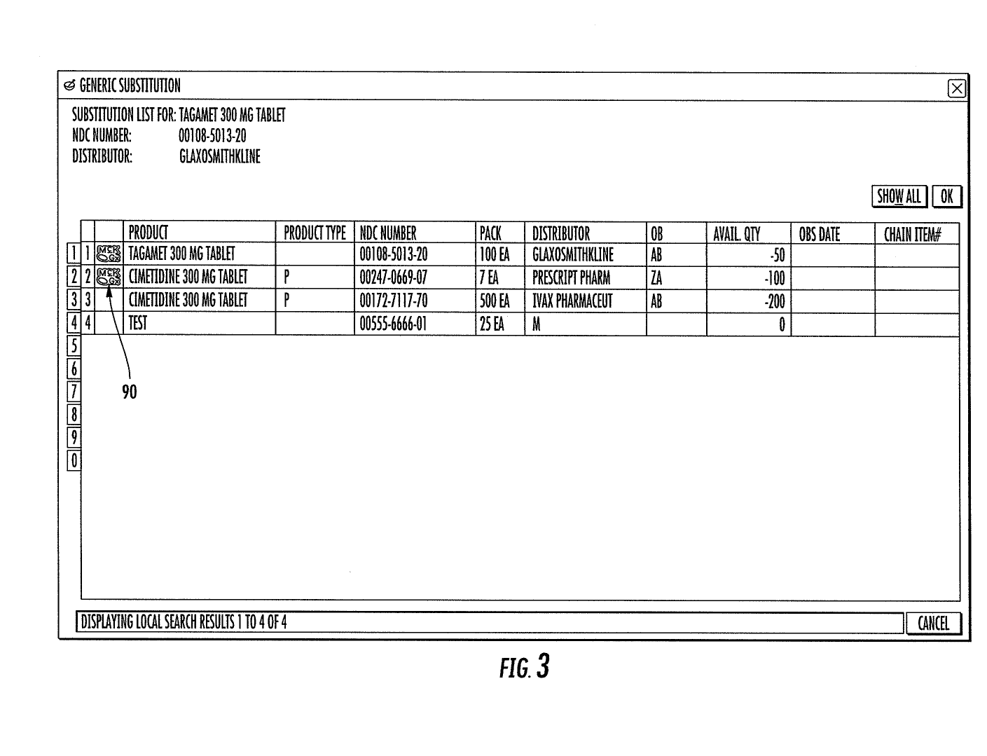

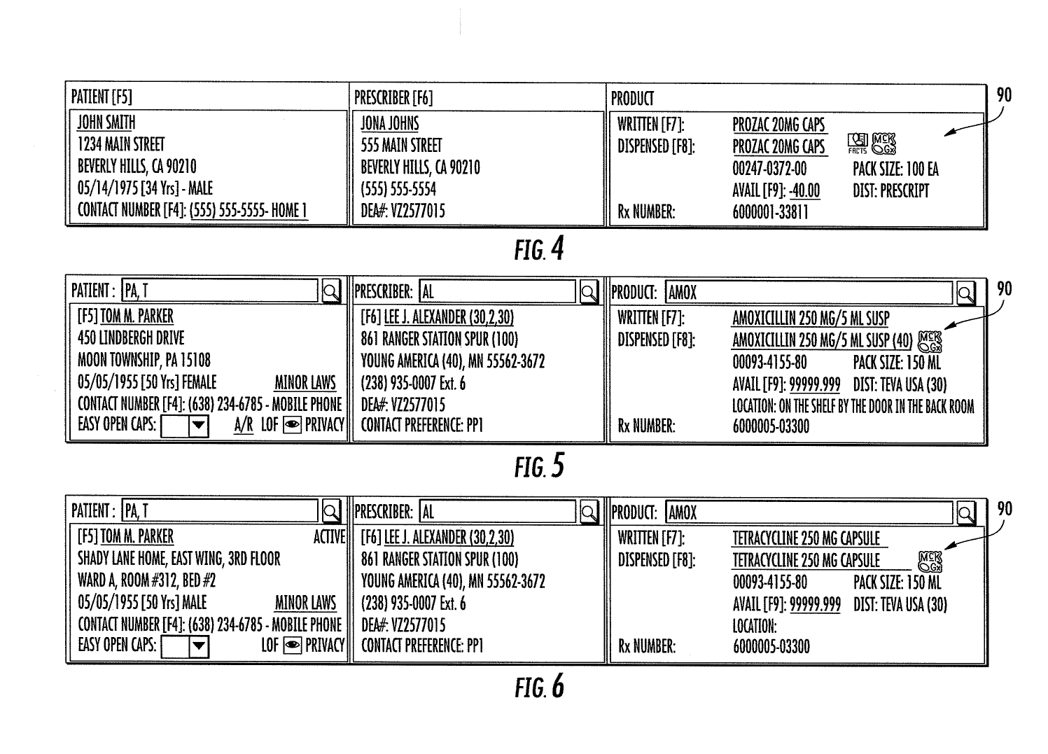

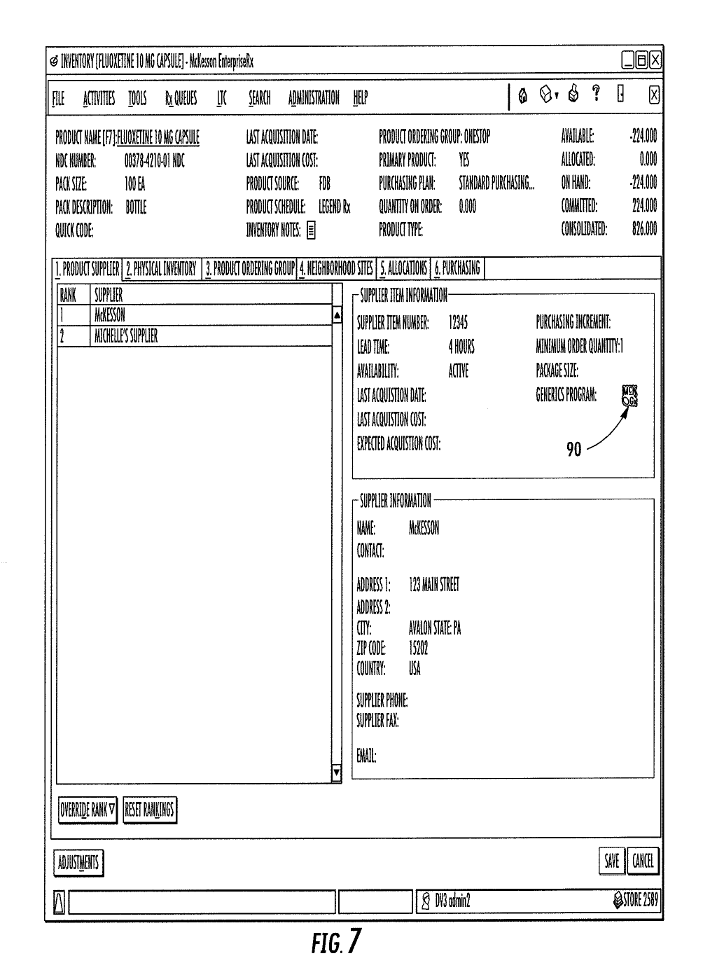

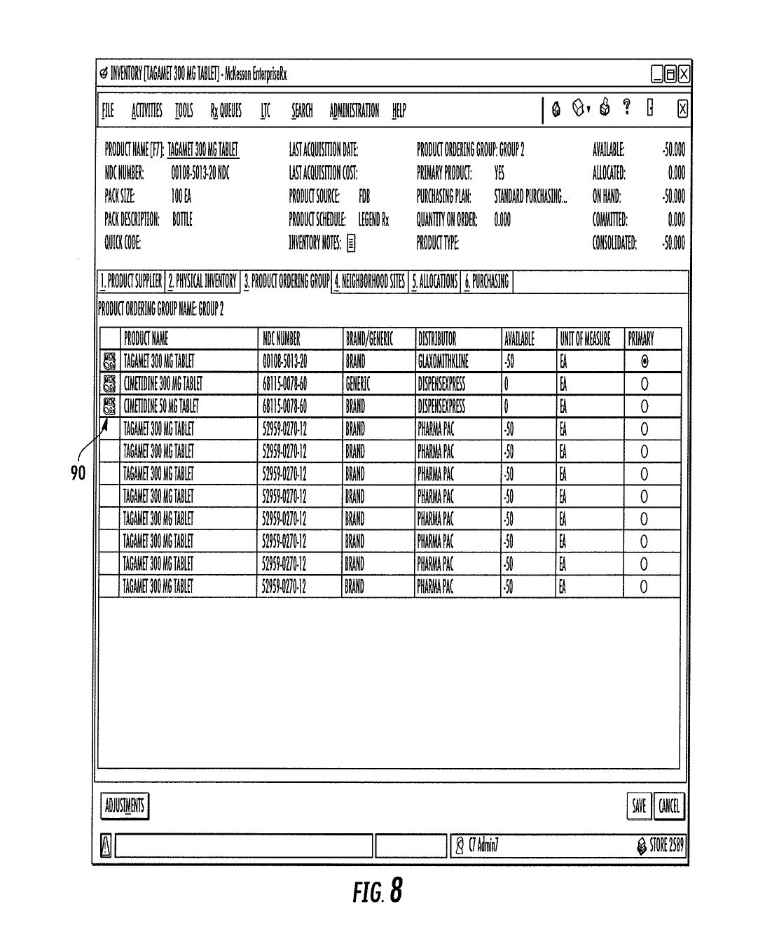

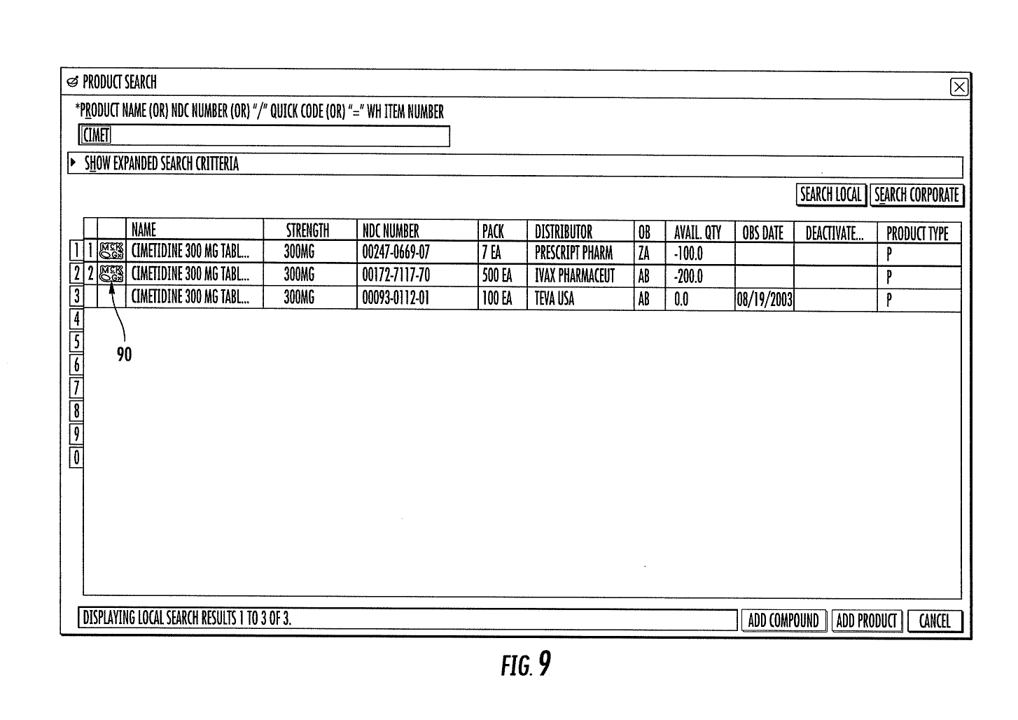

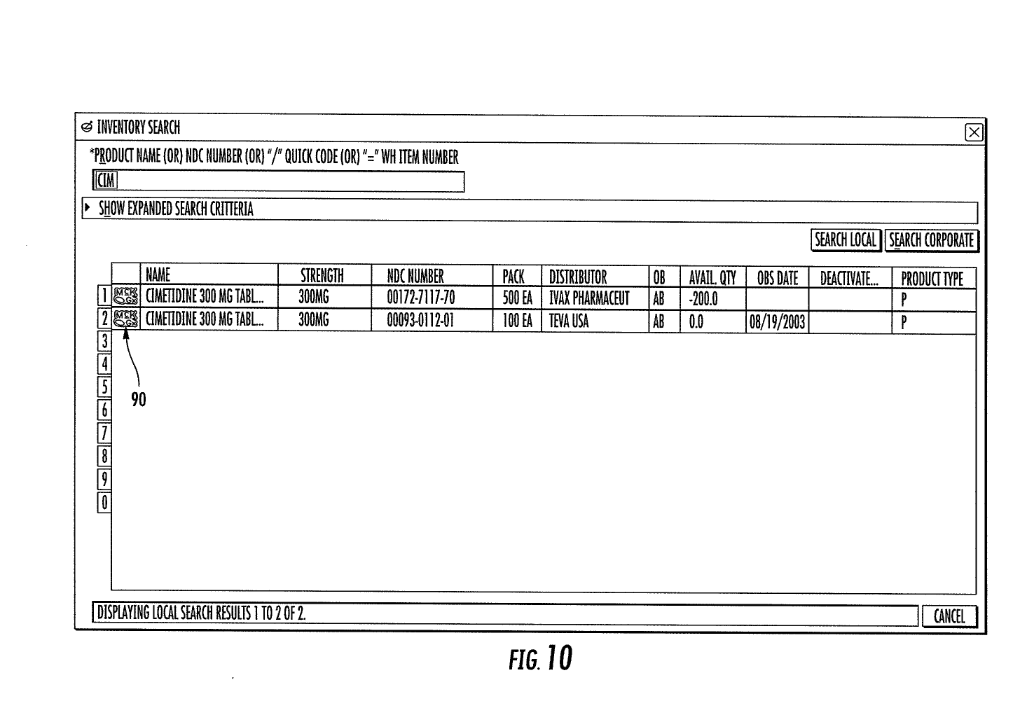

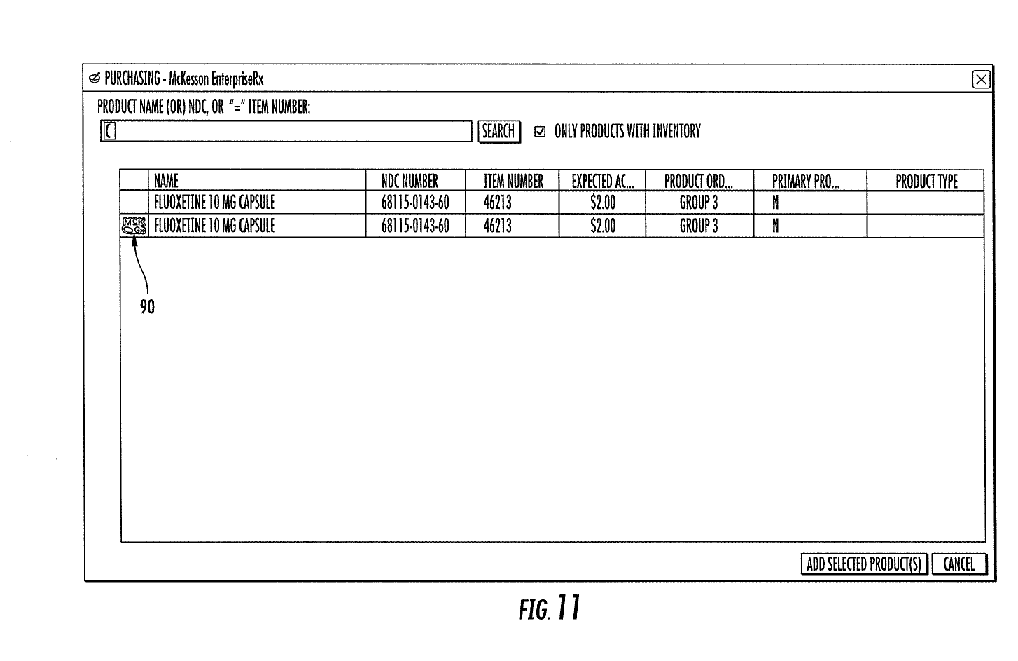

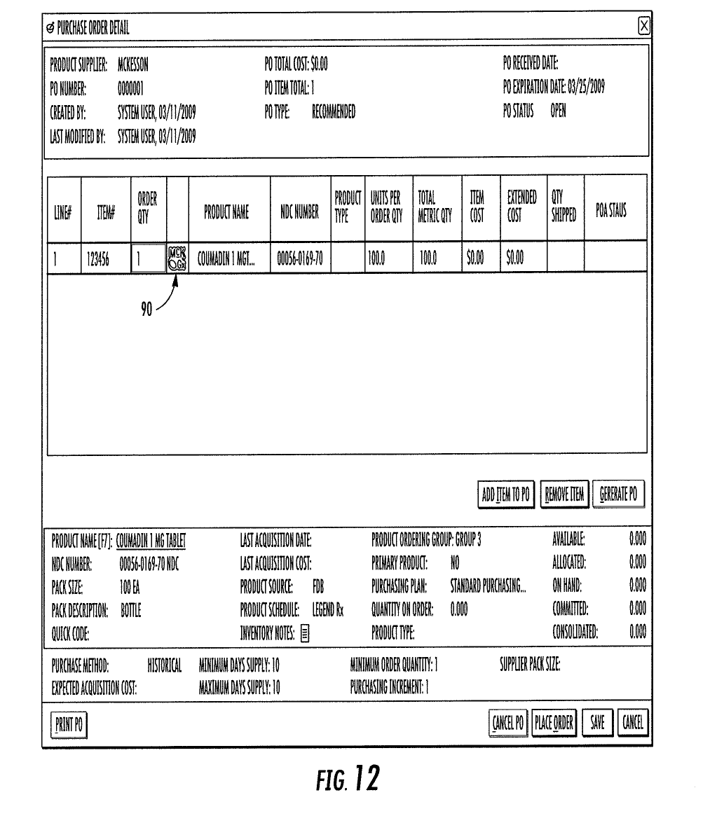

FIGS. 3-12 illustrate various examples of tabs, pages or screens that may be enabled to present the icon indicating that a corresponding item is a program generic according to an exemplary embodiment. Notably, the example drawings shown are not meant to be limiting, but instead are intended to illustrate both how the icon may be presented and the variety of tools into which the icon may be integrated. In this regard, FIG. 3 illustrates a screenshot of a generic substitution tool showing an example of an icon 90 according to an exemplary embodiment of the present invention. As can be seen from FIG. 3, inventory items associated with icons are moved to the top of the list of potential substitutions. FIG. 4 illustrates a full workflow header with an item indicated as being a program generic by virtue of its association with the icon 90 according to an exemplary embodiment of the present invention. FIG. 5 illustrates an express fill header with an item indicated as being a program generic by virtue of its association with the icon 90 according to an exemplary embodiment of the present invention. FIG. 6 illustrates a long term care header with an item indicated as being a program generic by virtue of its association with the icon 90 according to an exemplary embodiment of the present invention. FIG. 7 shows a supplier tab indicating supplier item information including information about an item that is in the generics program as indicated by the icon 90. FIG. 8 shows an example of a product ordering group tab with several products that are program generics as indicated by the icon 90. FIGS. 9 and 10 are screenshot of an example product search tab and an example inventory search tab, respectively. Each respective tab shows an example in which the icon 90 is used to indicate that one or more items are program generics. FIG. 11 illustrates a product search in purchasing/receiving tab with an item indicated as being a program generic by virtue of its association with the icon 90 according to an exemplary embodiment of the present invention. FIG. 12 illustrates a purchase order detail tab with an item indicated as being a program generic by virtue of its association with the icon 90 according to an exemplary embodiment of the present invention.

Some embodiments of the present invention may therefore enable distributors to provide a relatively easy way for remote facilities to identify products that are program generics so that such products may be substituted where appropriate with greater ease and frequency. Some embodiments may also provide a mechanism by which reports on remote facility activity may be generated to facilitate monitoring of generics program compliance.

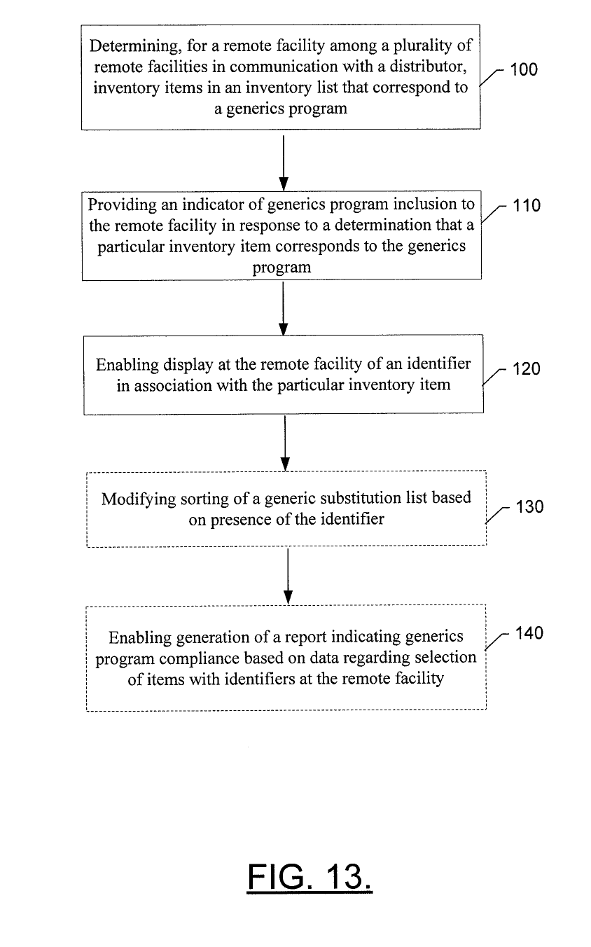

Embodiments of the present invention may therefore be practiced using an apparatus such as the one depicted in FIG. 2. However, other embodiments may be practiced in connection with a computer program product for performing embodiments of the present invention. FIG. 13 is a flowchart of a method and program product according to exemplary embodiments of the invention. Each block or step of the flowchart of FIG. 13, and combinations of blocks in the flowchart, may be implemented by various means, such as hardware, firmware, processor, circuitry and/or another device associated with execution of software including one or more computer program instructions. Thus, for example, one or more of the procedures described above may be embodied by computer program instructions, which may embody the procedures described above and may be stored by a storage device (e.g., storage device 54) and executed by processing circuitry (e.g., processor 52).

As will be appreciated, any such stored computer program instructions may be loaded onto a computer or other programmable apparatus (i.e., hardware) to produce a machine, such that the instructions which execute on the computer or other programmable apparatus implement the functions specified in the flowchart block(s) or step(s). These computer program instructions may also be stored in a computer-readable medium comprising memory that may direct a computer or other programmable apparatus to function in a particular manner, such that the instructions stored in the computer-readable memory produce an article of manufacture including instructions to implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

In this regard, a method according to one embodiment of the invention, as shown in FIG. 13, may include determining, for a remote facility among a plurality of remote facilities in communication with a distributor, inventory items in an inventory list that correspond to a generics program at operation 100. The method may further include providing an indicator of generics program inclusion to the remote facility in response to a determination that a particular inventory item corresponds to the generics program at operation 110 and enabling display at the remote facility of an identifier in association with the particular inventory item at operation 120.

In some cases, the method may include additional optional operations, some examples of which are shown in dashed lines in FIG. 13. In this regard, in an exemplary embodiment, the method may further include modifying sorting of a generic substitution list based on presence of the identifier at operation 130. Alternatively or additionally, the method may include enabling generation of a report indicating generics program compliance based on data regarding selection of items with identifiers at the remote facility at operation 140.

In some embodiments, modifications may be made to the operations described above. For example, in some cases, presenting compliance data may include determining inventory items that correspond to the generics program comprises utilizing contract provisions regarding a contract between the remote facility and the distributor. In some embodiments, providing the indicator may include providing the indicator along with a feed of inventory information to the remote facility. In an exemplary embodiment, enabling display of the identifier may include enabling display of a branded icon. Alternatively or additionally, enabling display of the identifier may include enabling display of the identifier on a plurality of tabs associated with a pharmacy management application. Other modifications are also possible. The modifications and optional operations may be included in any combination and in any order with respect to the operations 100-140 described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for providing management of a generics program comprising:
determining, for a remote facility among a plurality of remote facilities in communication with a distributor, inventory items in an inventory list that correspond to a generics program;
providing, via a processor, an indicator of generics program inclusion to the remote facility in response to a determination that a particular inventory item corresponds to the generics program; and
enabling display at the remote facility of an identifier in association with the particular inventory item.

2. The method of claim 1, wherein determining inventory items that correspond to the generics program comprises utilizing contract provisions regarding a contract between the remote facility and the distributor.

3. The method of claim 1, wherein providing the indicator comprises providing the indicator along with a feed of inventory information to the remote facility.

4. The method of claim 1, further comprising modifying sorting of a generic substitution list based on presence of the identifier.

5. The method of claim 1, further comprising enabling generation of a report indicating generics program compliance based on data regarding selection of items with identifiers at the remote facility.

6. The method of claim 1, wherein enabling display of the identifier comprises enabling display of a branded icon.

7. The method of claim 1, wherein enabling display of the identifier comprises enabling display of the identifier on a plurality of tabs associated with a pharmacy management application.

8. A computer program product for providing management of a generics program, the computer program product comprising at least one computer-readable storage medium having computer-executable program code instructions stored therein, the computer-executable program code instructions comprising:
program code instructions for determining, for a remote facility among a plurality of remote facilities in communication with a distributor, inventory items in an inventory list that correspond to a generics program;
program code instructions for providing an indicator of generics program inclusion to the remote facility in response to a determination that a particular inventory item corresponds to the generics program; and
program code instructions for enabling display at the remote facility of an identifier in association with the particular inventory item.

9. The computer program product of claim 8, wherein program code instructions for determining inventory items that correspond to the generics program include instructions for utilizing contract provisions regarding a contract between the remote facility and the distributor.

10. The computer program product of claim 8, wherein program code instructions for providing the indicator include instructions for providing the indicator along with a feed of inventory information to the remote facility.

11. The computer program product of claim 8, further comprising program code instructions for modifying sorting of a generic substitution list based on presence of the identifier.

12. The computer program product of claim 8, further comprising program code instructions for enabling generation of a report indicating generics program compliance based on data regarding selection of items with identifiers at the remote facility.

13. The computer program product of claim 8, wherein program code instructions for enabling display of the identifier include instructions for enabling display of a branded icon.

14. The computer program product of claim 8, wherein program code instructions for enabling display of the identifier include instructions for enabling display of the identifier on a plurality of tabs associated with a pharmacy management application.

15. An apparatus comprising processing circuitry configured to:
determine, for a remote facility among a plurality of remote facilities in communication with a distributor, inventory items in an inventory list that correspond to a generics program;
provide an indicator of generics program inclusion to the remote facility in response to a determination that a particular inventory item corresponds to the generics program; and
enable display at the remote facility of an identifier in association with the particular inventory item.

16. The apparatus of claim 15, wherein the processing circuitry is further configured to determine inventory items that correspond to the generics program utilizing contract provisions regarding a contract between the remote facility and the distributor.

17. The apparatus of claim 15, wherein the processing circuitry is configured to provide the indicator along with a feed of inventory information to the remote facility.

18. The apparatus of claim 15, wherein the processing circuitry is further configured to modify sorting of a generic substitution list based on presence of the identifier.

19. The apparatus of claim 15, wherein the processing circuitry is further configured to enable generation of a report indicating generics program compliance based on data regarding selection of items with identifiers at the remote facility.

20. The apparatus of claim 15, wherein the processing circuitry is configured to enable display of the identifier including enabling display of the identifier on a plurality of tabs associated with a pharmacy management application.
